(19) United States
(12) Patent Application Publication
(10) Pub. No.: US 2017/0273135 A1
(43) Pub. Date: Sep. 21, 2017

(54) METHODS OF MANAGING LONG INACTIVITY PERIODS IN NON-FULL DUPLEX OPERATION

(71) Applicant: Telefonaktiebolaget LM Ericsson (publ), Stockholm (SE)

(72) Inventors: Iana Siomina, Täby (SE); Muhammad Kazmi, Bromma (SE)

(73) Assignee: Telefonaktiebolaget LM Ericsson (publ), Stockholm (SE)

(21) Appl. No.: 15/320,868

(22) PCT Filed: Oct. 3, 2016
(86) PCT No.: PCT/SE2016/050938

§ 371 Date: Dec. 21, 2016

Related U.S. Application Data
(60) Provisional application No. 62/242,015, filed on Oct. 15, 2015.

(51) Int. Cl. H04W 76/04; H04W 68/02; H04L 5/14; H04W 52/02

(52) U.S. Cl. CPC H04W 76/048; H04W 52/0216; H04W 52/0229; H04W 68/02; H04L 5/14; H04W 88/02

(57) ABSTRACT

Systems and methods relating to non-full duplex operation in a Discontinuous Reception (DRX) mode of operation with long inactivity periods are disclosed. In some embodiments, a method of operation of a first node for a cellular communications network comprises obtaining a configuration for non-full duplex operation in a multi-tier DRX mode of operation with long inactivity periods. The configuration comprises at least one long inactivity configuration parameter being greater than a threshold. The method further comprises applying the configuration. In this manner, the first node is enabled to operate under non-FDX configuration with long inactivity periods while ensuring a required performance level and/or well-defined and consistent behavior.

### RELATED APPLICATIONS

This application claims the benefit of provisional patent application Ser. No. 62/242,015, filed Oct. 15, 2016, the disclosure of which is hereby incorporated herein by reference in its entirety.

### TECHNICAL FIELD

The present disclosure relates to managing long inactivity periods in non-Full Duplex (FDX) operation.

### BACKGROUND

1 Extended Discontinuous Reception (eDRX)

Power consumption is important for User Equipment devices (UEs) using battery or an external power supply and its importance increases with the continued growth of device populations and more demanding use cases. The importance can be illustrated by following scenarios, e.g.:
For Machine-to-Machine (M2M) use cases like sensors that run on battery, it is a major cost to exchange or charge the batteries on site for a large amount of devices, and the battery lifetime may even determine the device's lifetime if charging or replacing the battery is not to be expected;
Even for scenarios where UEs may consume power from an external power supply, it may be desirable to consume less power for energy efficiency purposes.

Enhancing Discontinuous Reception (DRX) operation, currently discussed in 3^{rd} Generation Partnership Project (3GPP), is a way to improve battery saving in the UE. DRX makes the UE reachable during predefined occasions without resulting in unnecessary signaling. As currently defined, DRX cycles in Long Term Evolution (LTE) can at most be 2.56 seconds and thus would not allow for sufficient power savings for UEs that only need to wake-up infrequently (e.g., every few or tens of minutes) for data. Hence, DRX cycle extension is required in order to enable significant battery savings for such UEs. Furthermore, the DRX cycle can be set depending on the data delay tolerance and power saving requirements, thus providing a flexible solution for achieving significant UE battery savings.

Currently, 3GPP is defining eDRX operation for UEs in CONNECTED mode in LTE and for UEs in IDLE mode in LTE and Universal Terrestrial Radio Access (UTRA). In LTE, the eDRX in IDLE mode is based on the Hyper System Frame Number (H-SFN) concept.

1.1 eDRX in LTE

### 1.1.1 In CONNECTED Mode

For CONNECTED mode, the eDRX concept still remains unclear, but it was decided to extend the DRX cycle up to 10.24 seconds, which may for example look as illustrated in FIG. 1A or FIG. 1B.

### 1.1.2 In IDLE Mode

The H-SFN is a means to extend the current System Frame Number (SFN) range, which is limited to 0 to 1023, as depicted in FIG. 2A. As an example, in FIG. 2A, 10 bits of extension are used, where each H-SFN contains 1024 SFNs and therefore spans across 10.24 seconds. However, the actual H-SFN range is still not decided.

For extended idle mode DRX, the paging frames for the UE consist of:
1. H-SFN value or values: that provide the hyper frame/frames at which the UE may be paged, i.e., the Paging Hyper-frames (PH).
2. SFN value or values: that provide the legacy frame/frames at which the UE expects to be paged within each PH. The legacy paging frames are within a Paging Window (PW).
   This is illustrated in FIG. 2B.
   1.1.3 eDRX in UTRA

In eDRX for UTRA for IDLE UEs, the DRX cycle is prolonged to some seconds which is much longer than the legacy DRX cycles. The DRX cycle consists of a long sleep period, then the UE wakes up to a Paging Transmission Window (PTW) where there are N_PTW paging occasions with the legacy Packet Switched (PS) DRX cycle. This is shown in FIG. 3.

### 2 (Normal) DRX in LTE

### 2.1 General Principles

In LTE, DRX has been introduced as one of the key solutions to conserve battery power in a mobile terminal. DRX is characterized by the following:
Per UE mechanism, as opposed to per radio bearer;
May be used in RRC_IDLE and RRC_CONNECTED; In RRC_CONNECTED, the enhanced or evolved Node B (eNB)/UE may initiate the DRX mode when there are no outstanding/new packets to be transmitted/received; in RRC_IDLE
   2^{nd} Generation (2G) and 3^{rd} Generation (3G) terminal use DRX in IDLE state to increase battery life time. High Speed Packet Access (HSPA) and LTE have introduced DRX also for connected state;
Available DRX values are controlled by the network and start from non-DRX up to x seconds;
Hybrid Automatic Repeat Request (HARQ) operation related to data transmission is independent of DRX operation and the UE wakes up to read the Physical Downlink Control Channel (PDCCH) for possible retransmissions and/or Acknowledgement/Negative Acknowledgement (ACK/NAK) signaling regardless of DRX. In the downlink, a timer is used to limit the time the UE stays awake awaiting for a retransmission;
When DRX is configured, the UE may be further configured with an “on-duration” timer during which time the UE monitors the PDCCHs for possible allocations;
When DRX is configured, periodic Channel Quality Indication (CQI) reports can only be sent by the UE during the “active-time.” Radio Resource Control (RRC) can further restrict periodic CQI reports so that they are only sent during the on-duration;
eNB does not transmit packets to UE during the sleep mode.

RRC_CONNECTED mode DRX should not be mixed up with DRX in IDLE mode which the mobile device is set into after a prolonged time of air interface inactivity. DRX in IDLE mode is also known as paging DRX, i.e. the time the mobile device can go to sleep between two paging messages which could contain a command for the mobile device to wake up again and change back to RRC_CONNECTED state. This DRX is much less fine grained and measured in hundreds of milliseconds or even seconds.

### 2.2 Parameters Related to DRX

The following definitions apply to DRX in Evolved Universal Mobile Telecommunications System (UMTS) Radio Access Network (E-UTRAN):
on-duration: duration in downlink subframes that the UE waits for, after waking up from DRX, to receive PDCCHs. If the UE successfully decodes a PDCCH, the UE stays awake and starts the inactivity timer;
inactivity-timer: duration in downlink subframes that the UE waits to successfully decode a PDCCH, from the last successful decoding of a PDCCH, failing which it re-enters DRX. The UE shall restart the inactivity timer following a single successful decoding of a PDCCH for a first transmission only (i.e., not for retransmissions);
active-time: total duration that the UE is awake. This includes the “on-duration” of the DRX cycle, the time UE is performing continuous reception while the inactivity timer has not expired, and the time UE is performing continuous reception while waiting for a downlink retransmission after one HARQ Round Trip Time (RTT). Based on the above, the minimum active time is of length equal to on-duration, and the maximum is undefined (infinite).

Of the above parameters, the on-duration and the inactivity-timer are of fixed lengths, while the active-time is of varying lengths based on scheduling decision and UE decoding success. Only on-duration and inactivity-timer duration are signaled to the UE by the eNB:
There is only one DRX configuration applied in the UE at any time;
UE shall apply an on-duration on wake-up from DRX sleep.
   DRX mode in LTE is illustrated in FIG. 4.

DRX is triggered by means of an inactivity time known as DRX. As can be seen from FIG. 4, the UE activity time may be extended if PDCCH is received during ON duration time. However, it may also be shorten by a Medium Access Control (MAC) DRX command, upon reception of which the UE stops onDurationTimer and drx-InactivityTimer.

If PDCCH has not been successfully decoded during the on-duration, the UE shall follow the DRX configuration (i.e., the UE can enter DRX sleep if allowed by the DRX configuration):
This applies also for the subframes where the UE has been allocated predefined resources.
If it successfully decodes a PDCCH for a first transmission, the UE shall stay awake and start the inactivity timer (even if a PDCCH is successfully decoded in the subframes where the UE has also been allocated predefined resources) until a MAC control message tells the UE to re-enter DRX, or until the inactivity timer expires. In both cases, the DRX cycle that the UE follows after re-entering DRX is given by the following rules:
   If a short DRX cycle is configured, the UE first follows the short DRX cycle and after a longer period of inactivity the UE follows the long DRX cycle; if short DRX cycle is used, the long cycle will be a multiple of the short cycle;
      Durations for long and short DRX are configured by the RRC. The transition between the short and long DRX cycles is determined by the eNB MAC commands (if the command is received and short DRX is configured, the UE will (re)start drxShortCycleTimer and use the short DRX cycle; otherwise, long DRX will be used) or by the UE based on an activity timer
   Else the UE follows the long DRX cycle directly.
Some parameters that may be configured by the network:
onDurationTimer can be (in PDCCH subframes): 1, 2, 3, 4, 5, 6, 8, 10, 20, 30, 40, 50, 60, 80, 100, and 200
drx-InactivityTimer can be (in PDCCH subframes): 1, 2, 3, 4, 5, 6, 8, 10, 20, 30, 40, 50, 60, 80, 100, 200, 300, 500, 750, 1280, 1920, 2560. A specific value may also be configured if the UE supports In-Device Coexistence (IDC)
longDRX-CycleStartOffset (in subframes): depending on the cycle length, but up to 2559
shortDRX-cycle (in subframes): 2, 5, 8, 10, 16, 20, 32, 40, 64, 80, 128, 160, 256, 320, 52, 640
   2.3 UE Active Time and UE Transmissions when Using DRX

When a DRX cycle is configured, the active time includes the time while:
onDurationTimer or drx-InactivityTimer or drx-RetransmissionTimer or mac-ContentionResolutionTimer is running; or
a scheduling request is sent on Physical Uplink Control Channel (PUCCH) and is pending; or
an uplink grant for a pending HARQ retransmission can occur and there is data in the corresponding HARQ buffer; or
a PDCCH indicating a new transmission addressed to the Cell Radio Network Temporary Identifier (C-RNTI) of the UE has not been received after successful reception of a random access response for the preamble not selected by the UE.

Generally, new transmissions can only take place during the active-time so that, when the UE is waiting for one retransmission only, it does not have to be “awake” during the RTT.

When not in Active Time, type-0-triggered Sounding Reference Signal (SRS) shall not be reported.

If CQI masking (cqi-Mask) is setup by upper layers:
when onDurationTimer is not running, CQI/Precoding Matrix Indicator (PMI)/Rank Indicator (RI)/Procedure Transaction Identity (PTI) on PUCCH shall not be reported,
   else:
when not in active time, CQI/PMI/RI/PTI on PUCCH shall not be reported.
   That is, cqi-Mask is effectively limiting CQI/PMI/PTI/RI reports to the on-duration period of the DRX cycle, and the same one value applies for all serving cells (the associated functionality is common, i.e., not performed independently for each cell).

There are a few exceptions:
Regardless of whether the UE is monitoring PDCCH or not, the UE receives and transmits HARQ feedback and transmits type-1-triggered SRS when such is expected.

A UE may optionally choose to not send CQI/PMI/RI/PTI reports on PUCCH and/or type-0-triggered SRS transmissions for up to 4 subframes following a PDCCH indicating a new transmission (uplink or downlink) received in subframe n−i, where n is the last subframe of active time and i is an integer value from 0 to 3. After active time is stopped due to the reception of a PDCCH or a MAC control element a UE may optionally choose to continue sending CQI/PMI/RI/PTI reports on PUCCH and/or SRS transmissions for up to 4 subframes. The choice not to send CQI/PMI/RI/PTI reports on PUCCH and/or type-0-triggered SRS transmissions is not applicable for subframes where onDurationTimer is running and is not applicable for subframes n−i to n.

### 3 Non-Full Duplex (FDX) Operation

### 3.1 Duplex Configuration

A duplex communication system is a point-to-point system composed of two connected parties or devices that can communicate with one another in both directions. A Half-Duplex (HDX) system provides communication in both directions, but only one direction at a time (not simultaneously). A FDX, or sometimes double-duplex system, allows communication in both directions, and, unlike HDX, allows this to happen simultaneously. Time Division Duplexing (TDD) is the application of time division multiplexing to separate outward and return signals, i.e. operating over a HDX communication link. Frequency Division Duplexing (FDD) means that the transmitter and the receiver operate at different carrier frequencies, typically separated by a frequency offset.

LTE specification enables FDD and TDD operation modes. Additionally; HDX operation is also specified, which is essentially FDD operation mode but with transmission and receptions not occurring simultaneously as in TDD. HDX mode has advantages with some frequency arrangements where the duplex filter may be unreasonable, resulting in high cost and/or high power consumption. Since Evolved UTRA (E-UTRA) Absolute Radio Frequency Channel Number (EARFCN) is unique, by knowing it, it is possible to determine the frequency band, which is either FDD or TDD. However, it may be more difficult to find difference between FDX FDD and HDX FDD (HD-FDD) without explicit information since the same FDD band can be used as full FDD or HD-FDD.

In 3GPP, two radio frame structure types are currently supported: Type 1 (applicable to FDD) and Type 2 (applicable to TDD).

Transmissions in multiple cells can be aggregated where up to four secondary cells can be used in addition to the Primary Cell (PCell). In case of multi-cell aggregation, the UE currently assumes the same frame structure is used in all the serving (primary and secondary) cells.

### 3.1.1 FDD

Frame structure type 1 is applicable to both FDX and HDX FDD, and it is as illustrated in FIG. 5. For FDD, ten subframes are available for downlink transmission and ten subframes are available for uplink transmissions in each 10 millisecond (ms) interval. Uplink and downlink transmissions are separated in the frequency domain. In HDX FDD operation, the UE cannot transmit and receive at the same time while there are no such restrictions in FDX FDD. There is no need to have a guard period for FDX FDD. For HD-FDD operation, a guard period is created by the UE by not receiving the last part of a downlink subframe immediately preceding an uplink subframe from the same UE.

### 3.1.2 TDD

The frame structure type 2, applicable for TDD, is as illustrated in FIG. 6.

### 3.1.2.1 Uplink/Downlink TDD Configurations

The table below shows uplink/downlink TDD configurations defined so far in 3GPP, where, for each subframe in a radio frame, “D” denotes the subframe is reserved for downlink transmissions, “U” denotes the subframe is reserved for uplink transmissions, and “S” denotes a special subframe with the three fields DwPTS, GP (TDD guard period), and UpPTS. Choosing a specific uplink/downlink configuration may be determined, e.g., by traffic demand in downlink and/or uplink and network capacity in downlink and/or uplink.

| | Downlink- | | | | | | | | | | |
|---|---|---|---|---|---|---|---|---|---|---|---|
| | to- | | | | | | | | | | |
| | Uplink | | | | | | | | | | |
| Uplink- | Switch- | | | | | | | | | | |
| downlink | point | Subframe number | | | | | | | | | |
| configuration | periodicity | 0 | 1 | 2 | 3 | 4 | 5 | 6 | 7 | 8 | 9 |
| 0 | 5 ms | D | S | U | U | U | D | S | U | U | U |
| 1 | 5 ms | D | S | U | U | D | D | S | U | U | D |
| 2 | 5 ms | D | S | U | D | D | D | S | U | D | D |
| 3 | 10 ms | D | S | U | U | U | D | D | D | D | D |
| 4 | 10 ms | D | S | U | U | D | D | D | D | D | D |
| 5 | 10 ms | D | S | U | D | D | D | D | D | D | D |
| 6 | 5 ms | D | S | U | U | U | D | S | U | U | D |

Subframes 0 and 5 and DwPTS are always reserved for downlink transmission. UpPTS and the subframe immediately following the special subframe are always reserved for uplink transmission. The length of DwPTS and UpPTS depends on the combination of downlink and uplink cyclic prefix lengths and on the special subframe configuration (10 predefined special subframe configurations are defined in 3GPP Technical Specification (TS) 36.211). Typically, DwPTS is longer than UpPTS. In case multiple cells are aggregated, the UE may assume that the guard period of the special subframe in the different cells have an overlap of at least 1456·Tₛ.

### 3.1.3 Existing Capabilities Related to Duplex Configuration Support

Supported Radio Frequency (RF) band(s). Radio network nodes and UEs typically do not support all RF bands, but a subset of the RF bands. Currently, the RF bands supported by the UE may be signaled to the serving eNB or positioning node (Evolved Serving Mobile Location Centre (E-SMLC)). Base stations typically declare supported RF bands; although some radio network nodes, e.g., Location Measurement Units (LMUs), may signal the RF bands they support to another node (e.g., positioning node). An RF band and the duplex mode may be indirectly indicated by the carrier frequency number (EARFCN), which is unique, and by knowing it, it is possible to determine the frequency band it belongs to. The RF band, in turn, is either FDD or TDD, though it is not possible to tell from EARFCN whether it is FDD or HD-FDD.

HD-FDD capability. The HD-FDD capability for UEs has been discussed, e.g., for low-cost devices. From the network side, HD-FDD may be supported by means of scheduling, which would also allow the radio network nodes to support both non HD-FDD and normal FDD UEs.

Downlink Carrier Aggregation (CA) with different uplink/downlink TDD configurations. In Release 11, this capability becomes mandatory for all Release 11 UEs supporting TDD and inter-band CA (downlink only).

Device-to-Device (D2D) capability, since the UE operates in a HDX mode in D2D/Proximity Services (ProSe).

### 3.2 Network Deployments Using Non-FDX Operation Modes

Non-FDX operation modes, e.g. HD-FDD or TDD, may have some advantages such as lower device complexity (e.g., no need for duplex filter), channel reciprocity (the channel estimates on uplink may very well reflect the channel in downlink, especially for slow-varying channels), and possibility to better adapt spectrum utilization to the unbalanced downlink and uplink traffic. A typical disadvantage, however, is the generated co-channel interference and even inter-channel/inter-band interference, which requires, e.g., additional rather large guard bands to reduce unwanted emissions to other systems.

Below, some examples of deployments using non-FDX operation modes are provided. The current disclosure also provides the means to enable and/or improve performance in such deployments, without precluding also other deployments.

### 3.2.1 Single- and Multi-Carrier Deployments

Non-FDX operation may be used in single- or multi-carrier deployments, with the same or different duplex configurations or even different duplex modes (e.g., FDD and TDD) in different carriers, which may be determined by the spectrum availability in the area, wireless communications system purpose, services, and traffic needs.

### 3.2.2 Dynamic TDD

Typically, dynamic TDD operation refers to changing TDD configuration over a time period on a carrier of a single- or multi-carrier deployment, but such operation may also be implemented over multiple carriers.

### 3.2.3 Different Uplink Downlink Configurations

It has been agreed in 3GPP that all UEs should support different uplink/downlink configurations on different bands. This applies for non-CA operation, but also for inter-band CA (currently the UEs support downlink CA for inter-band, but uplink CA for inter-band is likely to be supported in a later release too). As mentioned earlier, a specific uplink/downlink configuration may be decided based on different factors; e.g.; traffic demand in downlink and/or uplink.

In the current standard, different uplink/downlink configurations in different cells are assumed to be statically configured. But in the prior art, different uplink/downlink configurations may be configured statically or dynamically in different bands, only in presence of a sufficient inter-band separation. Indeed, the possibility of having different uplink/downlink configurations can also give more flexibility for dynamic TDD and hence can be combined with the latter, which, however, would make interference coordination in the network more challenging in case of insufficient separation between bands or especially on the same carrier.

### SUMMARY

Systems and methods relating to non-full duplex operation in a Discontinuous Reception (DRX) mode of operation with long inactivity periods are disclosed. In some embodiments, a method of operation of a first node for a cellular communications network comprises obtaining a configuration for non-Full Duplex (FDX) operation in a multi-tier DRX mode of operation with long inactivity periods. The configuration comprises at least one long inactivity configuration parameter being greater than a threshold. The method further comprises applying the configuration. In this manner, the first node is enabled to operate under non-FDX configuration with long inactivity periods while ensuring a required performance level and/or well-defined and consistent behavior.

In some embodiments, the multi-tier DRX mode of operation is a two-tier DRX mode of operation that utilizes a first DRX cycle that defines a set of first DRX ON periods and a second DRX cycle that defines, during each first DRX ON period, a set of second DRX ON periods within the first DRX ON period during which the first node is awake.

In some embodiments, the multi-tier DRX mode of operation is a two-tier DRX mode of operation for the first node when operating in IDLE mode that utilizes a first DRX cycle that defines a set of first DRX ON periods and a second DRX cycle that defines, during each first DRX ON period, a set of second DRX ON periods within the first DRX ON period during which the first node is awake.

In some embodiments, the multi-tier DRX mode of operation is a two-tier DRX mode of operation that utilizes a first DRX cycle that defines a set of first Paging Hyper-frames (PHs) and a second DRX cycle that defines, during each paging hyper-frame, a set of paging frames within the paging hyper-frame during which the first node expects to be paged.

In some embodiments, the at least one long inactivity configuration parameter comprises an inactivity period that is greater than a threshold.

In some embodiments, the at least one long inactivity configuration parameter comprises a Paging Window (PW) size that is greater than a threshold.

In some embodiments, the at least one long inactivity configuration parameter comprises an inactivity period that is greater than an inactivity period threshold and a PW size that is greater than a PW size threshold.

In some embodiments, the at least one long inactivity configuration parameter comprises a PW size that is large enough to cover a certain minimum number of signal samples or subframes of a specific type.

In some embodiments, the configuration further comprises a non-FDX configuration. In some embodiments, the non-FDX configuration comprises at least one of the following: a non-FDX configuration that provides an amount of time or number of subframes available for an activity type of the first node that is greater than a threshold, a non-FDX configuration that provides a number of subframes of a certain type that is greater than or equal to a threshold, a non-FDX configuration that provides a number of signal instances that is greater than or equal to a threshold, and a non-FDX configuration that provides a number of uplink/downlink switching points that is greater than a threshold.

In some embodiments, the non-FDX configuration is a Time Division Duplexing (TDD) configuration. In other embodiments, the non-FDX configuration is a half-duplex Frequency Division Duplexing (FDD) configuration.

In some embodiments, the first node is a User Equipment device (UE).

Embodiments of a first node for a cellular communications network are also disclosed. In some embodiments, the first node is adapted to obtain a configuration for non-FDX operation in a multi-tier DRX mode of operation with long inactivity periods. The configuration comprises at least one long inactivity configuration parameter being greater than a threshold. The first node is further adapted to apply the configuration. In some embodiments, the first node is further adapted to perform the method of operation of the first node according to any one of the embodiments disclosed herein.

In some embodiments, a first node for a cellular communications network comprises at least one processor, and memory comprising instructions executable by the at least one processor whereby the first node is operable to: obtain a configuration for non-FDX operation in a multi-tier DRX mode of operation with long inactivity periods, the configuration comprising at least one long inactivity configuration parameter being greater than a threshold, and apply the configuration.

In some embodiments, a first node for a cellular communications network comprises an obtaining module operable to obtain a configuration for non-FDX operation in a multi-tier DRX mode of operation with long inactivity periods, the configuration comprising at least one long inactivity configuration parameter being greater than a threshold. The first node further comprises an applying module operable to apply the suitable configuration.

Embodiments of a method of operation of a node for a cellular communications network are also disclosed. In some embodiments, the method of operation of a node for a cellular communications network comprises determining, for at least one other node, a need for a configuration for non-FDX operation in a multi-tier DRX mode of operation with long inactivity periods. The configuration comprises at least one long inactivity configuration parameter being greater than a threshold. The method further comprises obtaining the configuration for the at least one other node and configuring the at least one other node with the configuration.

In some embodiments, the multi-tier DRX mode of operation is a two-tier DRX mode of operation that utilizes a first DRX cycle that defines a set of first DRX ON periods and a second DRX cycle that defines, during each first DRX ON period, a set of second DRX ON periods within the first DRX ON period during which the other node is awake.

In some embodiments, the multi-tier DRX mode of operation is a two-tier DRX mode of operation for the first node when operating in IDLE mode that utilizes a first DRX cycle that defines a set of first DRX ON periods and a second DRX cycle that defines, during each first DRX ON period, a set of second DRX ON periods within the first DRX ON period during which the other node is awake.

In some embodiments, the multi-tier DRX mode of operation is a two-tier DRX mode of operation that utilizes a first DRX cycle that defines a set of first paging hyper-frames and a second DRX cycle that defines, during each paging hyper-frame, a set of paging frames within the paging hyper-frame during which the at least one other node expects to be paged.

In some embodiments, the at least one long inactivity configuration parameter comprises an inactivity period that is greater than a threshold.

In some embodiments, the at least one long inactivity configuration parameter comprises a PW size that is greater than a threshold.

In some embodiments, the at least one long inactivity configuration parameter comprises an inactivity period that is greater than an inactivity period threshold and a PW size that is greater than a PW size threshold.

Embodiments of a node for a cellular communications network are also disclosed. In some embodiments, the node is adapted to determine, for at least one other node, a need for a configuration for non-FDX operation in a multi-tier DRX mode of operation with long inactivity periods. The configuration comprises at least one long inactivity configuration parameter being greater than a threshold. The node is further adapted to obtain the configuration for the at least one other node and configure the at least one other node with the configuration. In some embodiments, the node is further adapted to perform the method of operation of the node according to any one of the embodiments disclosed herein.

In some embodiments, a node for a cellular communications network comprises at least one processor and memory comprising instructions executable by the at least one processor whereby the node is operable to determine, for at least one other node, a need for a configuration for non-FDX operation in a multi-tier DRX mode of operation with long inactivity periods, the configuration comprising at least one long inactivity configuration parameter being greater than a threshold. By executing the instructions, the node is further operable to obtain the configuration for the at least one other node and configure the at least one other node with the configuration.

In some embodiments, a node for a cellular communications network comprises a determining module, an obtaining module, and a configuring module. The determining module is operable to determine, for at least one other node, a need for a configuration for non-FDX operation in a multi-tier DRX mode of operation with long inactivity periods. The configuration comprises at least one long inactivity configuration parameter being greater than a threshold. The obtaining module is operable to obtain the configuration for the at least one other node, and the configuring module is operable to configure the at least one other node with the configuration.

In other embodiments, a method of operation of a first node for a cellular communications network comprises determining whether an adaptation is to be performed for a given non-FDX configuration and a long inactivity configuration which are configured for the first node for operating under the non-FDX configuration in a mufti-tier DRX mode of operation with long inactivity periods. The method further comprises, based on the determining, if adaptation is to be performed, adapting at least one activity procedure of the first node for the given non-FDX configuration and the long activity configuration.

In some embodiments, adapting the at least one activity procedure of the first node comprises adapting a measurement period. Further, in some embodiments, adapting the measurement period comprises adapting the measurement period such that the first node is enabled to obtain a sufficient number of samples for a respective measurement when operating under the non-FDX configuration and the long inactivity configuration.

In some embodiments, determining whether an adaptation is to be performed comprises determining that adaptation is to be performed if the given non-FDX configuration and the long inactivity configuration meet a predefined configuration.

In some embodiments, determining whether an adaptation is to be performed comprises determining that adaptation is to be performed if a long inactivity cycle defined by the long inactivity configuration is above a predefined threshold.

In some embodiments, the first node is a first UE.

In some other embodiments, a first node for a cellular communications network is adapted to determine whether an adaptation is to be performed for a given non-FDX configuration and long inactivity configuration which are configured for the first node for operating under the non-FDX configuration in a multi-tier DRX mode of operation with long inactivity periods. The first node is further adapted to, based on the determining, if adaptation is to be performed, adapt at least one activity procedure of the first node for the given non-FDX configuration and long activity configuration. In some embodiments, the first node is further adapted to perform the method of operation of the first node according to any one of the embodiments disclosed herein.

In some embodiments, a first node for a cellular communications network comprises at least one processor and memory comprising instructions executable by the at least one processor whereby the first node is operable to: determine whether an adaptation is to be performed for a given non-FDX configuration and long inactivity configuration which are configured for the first node for operating under the non-FDX configuration in a multi-tier DRX mode of operation with long inactivity periods and, based on the determining, if adaptation is to be performed, adapt at least one activity procedure of the first node for the given non-FDX configuration and long activity configuration.

In some embodiments, a first node for a cellular communications network comprises a determining module operable to determine whether an adaptation is to be performed for a given non-FDX configuration and long inactivity configuration which are configured for the first node for operating under the non-FDX configuration in a multi-tier DRX mode of operation with long inactivity periods. The first node further comprises an adapting module operable to, based on the determining, if adaptation is to be performed, adapt at least one activity procedure of the first node for the given non-FDX configuration and long activity configuration.

In some embodiments, a method of operation of a node for enabling operation of another node under non-FDX configuration comprises determining that the other node is or will be operating under non-FDX configuration and adapting at least one procedure for the other node for a given non-FDX configuration and long inactivity configuration.

In some embodiments, the method further comprises configuring the first node with the at least one adapted procedure.

In some embodiments, the method further comprises signaling, to a third node, the at least one adapted procedure.

In some embodiments, a node for enabling operation of another node under non-FDX configuration is adapted to determine that the other node is or will be operating under non-FDX configuration and adapt at least one procedure for the other node for a given non-FDX configuration and long inactivity configuration. In some embodiments, the node is further adapted to perform the method of operation of the node according to any one of the embodiments disclosed herein.

In some embodiments, a node for enabling operation of another node under non-FDX configuration comprises at least one processor and memory comprising instructions executable by the at least one processor whereby the node is operable to determine that the other node is or will be operating under non-FDX configuration and adapt at least one procedure for the other node for a given non-FDX configuration and long inactivity configuration.

In some embodiments, a node for enabling operation of another node under non-FDX configuration comprises a determining module operable to determine that the other node is or will be operating under non-FDX configuration and an adapting module operable to adapt at least one procedure for the other node for a given non-FDX configuration and long inactivity configuration.

Those skilled in the art will appreciate the scope of the present disclosure and realize additional aspects thereof after reading the following detailed description of the embodiments in association with the accompanying drawing figures.

### BRIEF DESCRIPTION OF THE DRAWINGS

The accompanying drawing figures incorporated in and forming a part of this specification illustrate several aspects of the disclosure, and together with the description serve to explain the principles of the disclosure.

FIGS. 1A and 1B illustrate examples of enhanced Discontinuous Reception (eDRX) configurations;

FIG. 2A illustrates a Hyper System Frame Number (H-SFN) concept;

FIG. 2B illustrates H-SFN based paging for eDRX;

FIG. 3 illustrates eDRX in Universal Terrestrial Radio Access (UTRA);

FIG. 4 illustrates Discontinuous Reception (DRX) in Long Term Evolution (LTE);

FIG. 5 illustrates frame structure type 1, which is applicable to both Full-Duplex (FDX) and Half-Duplex (HDX) Frequency Division Duplexing (FDD);

FIG. 6 illustrates frame structure type 2, which is applicable for Time Division Duplexing (TDD);

FIG. 7 illustrates one example of a cellular communications network;

FIG. 8 is a flow chart illustrating the operation of a first node according to some embodiments of the present disclosure;

FIG. 9 is a flow chart illustrating the operation of a first node according to some embodiments of the present disclosure;

FIG. 10 is a flow chart illustrating the operation of a second node according to some embodiments of the present disclosure;

FIG. 11 is a flow chart illustrating the operation of a first node according to some embodiments of the present disclosure;

FIG. 12 is a block diagram of a User Equipment device (UE) according to some embodiments of the present disclosure;

FIG. 13 is a block diagram of a UE according to some other embodiments of the present disclosure;

FIG. 14 is a block diagram of a network node according to some embodiments of the present disclosure; and

FIG. 15 is a block diagram of a network node according to some embodiments of the present disclosure.

### DETAILED DESCRIPTION

The embodiments set forth below represent information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure and the accompanying claims.

### Generalizations

Any two or more embodiments described below may be combined in any way with each other.

In some embodiments a non-limiting term User Equipment device (UE) is used. The UE herein can be any type of wireless device capable of communicating with network node or another UE over radio signals. The UE may also be a radio communication device, a target device, a Device-to-Device (D2D) UE, a machine type UE, or a UE capable of Machine-to-Machine (M2M) communication, a sensor equipped with a UE, an iPAD, a tablet, a mobile terminal, a smart phone, Laptop Embedded Equipped (LEE), Laptop Mounted Equipment (LME), Universal Serial Bus (USB) dongles, Customer Premises Equipment (CPE), etc.

Also in some embodiments generic terminology, “radio network node” or simply “network node,” is used. It can be any kind of network node which may comprise of a base station, a radio base station, a base transceiver station, a base station controller, a network controller, an enhanced or evolved Node B (eNB), a Node B, Multi-cell/Multicast Coordination Entity (MCE), a relay node, an access point, a radio access point, a Remote Radio Unit (RRU) Remote Radio Head (RRH), a core network node (e.g., a Trace Collection Entity (TCE), a Mobility Management Entity (MME), a Minimization of Drive Tests (MDT) node, a Multimedia Broadcast/Multicast Service (MBMS) node), or even an external node (e.g., a third party node, a node external to the current network), etc.

The term ‘radio node’ used herein may be used to denote a UE or a radio network node.

The embodiments are applicable to single carrier as well as to multicarrier or Carrier Aggregation (CA) operation of the UE in which the UE is able to receive and/or transmit data to more than one serving cells. The term CA is also called (e.g., interchangeably called) “multi-carrier system,” “multi-cell operation,” “multi-carrier operation,” and “multi-carrier” transmission and/or reception. In CA, one of the Component Carriers (CCs) is the Primary CC (PCC) or simply primary carrier or even anchor carrier. The remaining ones are called Secondary CCs (SCCs) or simply secondary carriers or even supplementary carriers. The serving cell is interchangeably called a Primary Cell (PCell) or Primary Serving Cell (PSC), Similarly the secondary serving cell is interchangeably called a Secondary Cell (SCell) or Secondary Serving Cell (SSC).

Non-Full-Duplex (FDX) may comprise, e.g., in general Universal Terrestrial Radio Access (UTRA) Time Division Duplexing (TDD), Long Term Evolution (LTE) TDD, Half-Duplex (HDX) Frequency Division Duplexing (FDD) (HD-FDD), or a specific configuration for uplink/downlink/special subframes, flexible or dynamic uplink/downlink subframe configurations. In the embodiments for the sake of consistency the term “subframe” is used. But the embodiments are applicable to any type of time resources. Non-limiting examples of time resources are symbol, time slot, interleaving duration or period, Transmission Time Interval (TTI), scheduling duration or period, subframe, resource assignment period or duration, frame, etc.

Herein, a radio node activity may comprise, e.g., any operation or activity performed by the UE for receiving and/or transmitting one or more signals from and/or to a cell. Examples of operation or activity are performing one or more of: a measurement (e.g., any of the measurements specified in 3^{rd} Generation Partnership Project (3GPP) Technical Specification (TS) 36.214 or 3GPP TS 25.215), a bunch of measurements (e.g., intra-frequency measurements for more than one cell, inter-frequency measurements over more than one carrier, etc.), Channel Quality Indication (CQI) reporting, Radio Link Monitoring (RLM), cell search, cell selection or reselection, handover, receiving a radio signal or channel or a physical signal, transmitting a radio signal or channel, etc. Specific examples of measurements are Reference Signal Received Power (RSRP), Reference Signal Received Quality (RSRQ), UE reception-transmission time difference, Reference Signal Time Difference (RSTD), Signal to Interference plus Noise Ratio (SINR), Signal to Noise Ratio (SNR), Cell Global Identifier (ID) (CGI) or Evolved UTRA (E-UTRA) CGI (ECGI) identification delay, Global System for Mobile Communications (GSM) carrier Received Signal Strength Indicator (RSSI), IEEE 802.11 Beacon RSSI, Common Pilot Channel (CPICH) Received Signal Code Power (RSCP), CPICH Ec/No, etc. Specific examples of channels are Physical Downlink Control Channel (PDCCH), Physical Downlink Shared Channel (PDSCH), Enhanced PDCCH (E-PDCCH), Machine Type Communication (MTC) PDCCH (M-PDCCH), MTC PDSCH (M-PDSCH), etc. Specific examples of physical signals are Reference Signals (RSs) like Discovery RSs (DRSs), Cell-Specific RSs (CRSs), Channel State Information (CSI) RSs (CSI-RSs), Primary Synchronization Signal (PSS)/Secondary Synchronization Signal (SSS), etc.

UE activity configuration may comprise herein one or more parameters characterizing UE activity, e.g., activity cycle, Discontinuous Reception (DRX) cycle, extended DRX (eDRX) cycle, ON DURATION time, etc.

The long inactivity configuration may be, e.g., the configuration characterized by one or more of:
the inactivity period is above a threshold;
ratio of inactivity period to activity period in the same cycle is larger than a certain threshold or ratio of activity period to inactivity period in the same cycle is below a certain threshold;
difficulty or UE inability to combine or average samples from different activity cycles. This may be due to any one or more of: implementation constraint such as limited memory and/or processing resources, very different radio conditions during any two successive activity durations of the corresponding successive activity cycles, larger difference (e.g., more than 6 decibels (dB)) between the measurement samples obtained during any two successive activity durations of the corresponding successive activity cycles, etc.;
eDRX (see, e.g., the Background above);
relation between the number of downlink subframes per frame and the activity period and/or inactivity period of the UE activity configuration, e.g., fewer downlink subframes such as 2 per frame and long inactivity cycles such as 10.24 seconds or longer;
relation between the number of uplink subframes per frame and the activity period and/or inactivity period of the UE activity configuration.

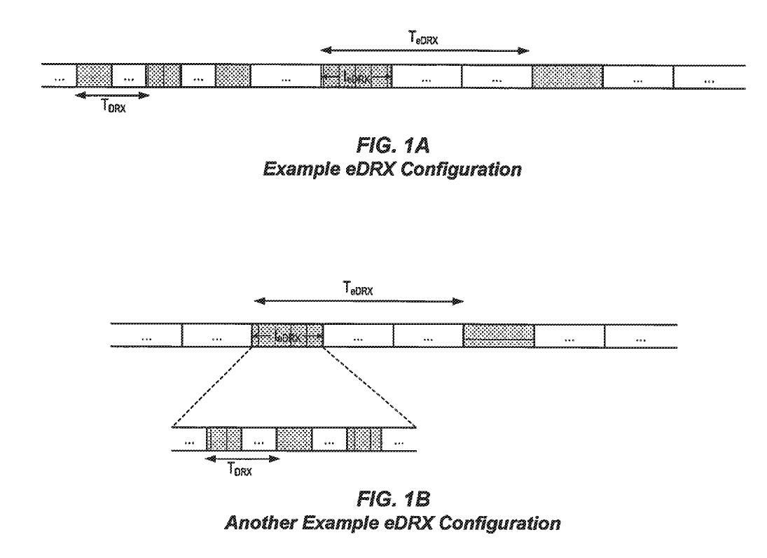

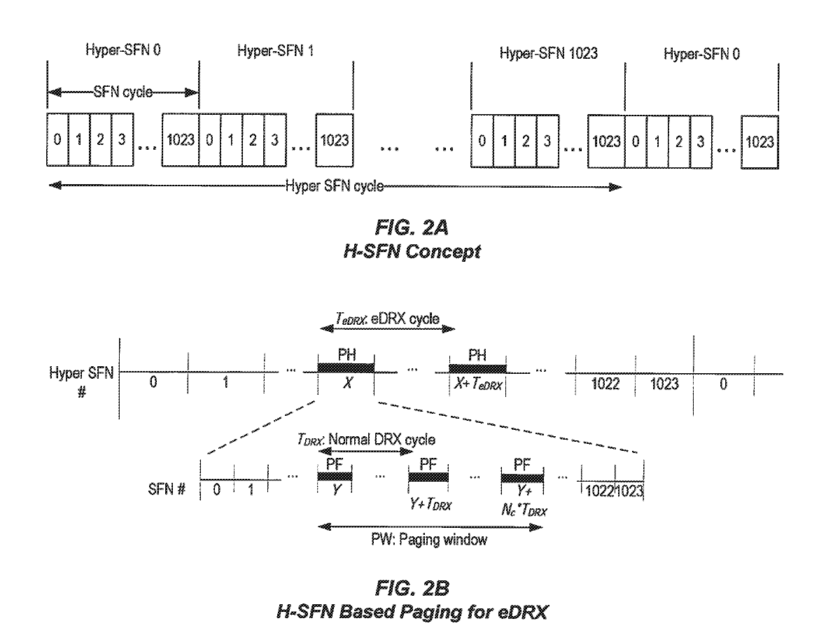

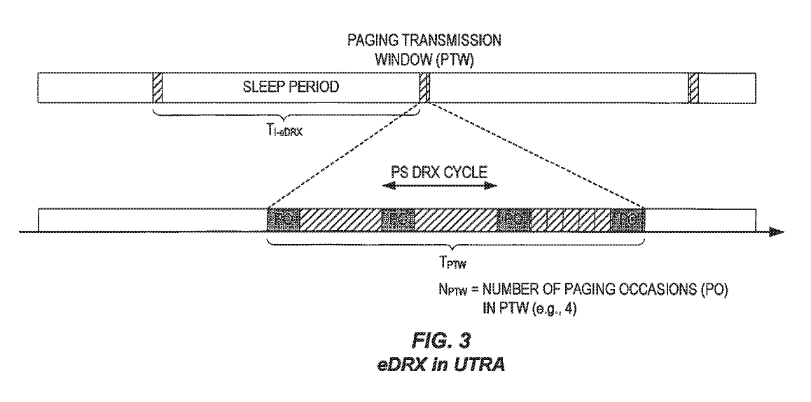

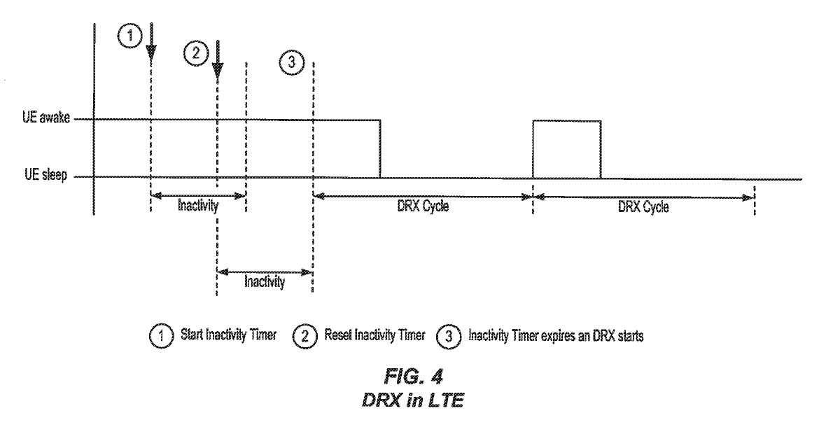

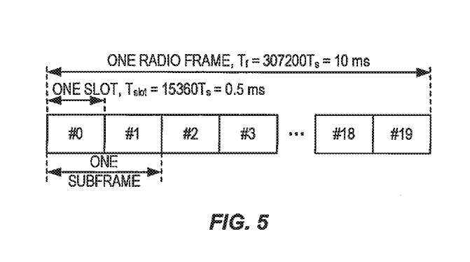

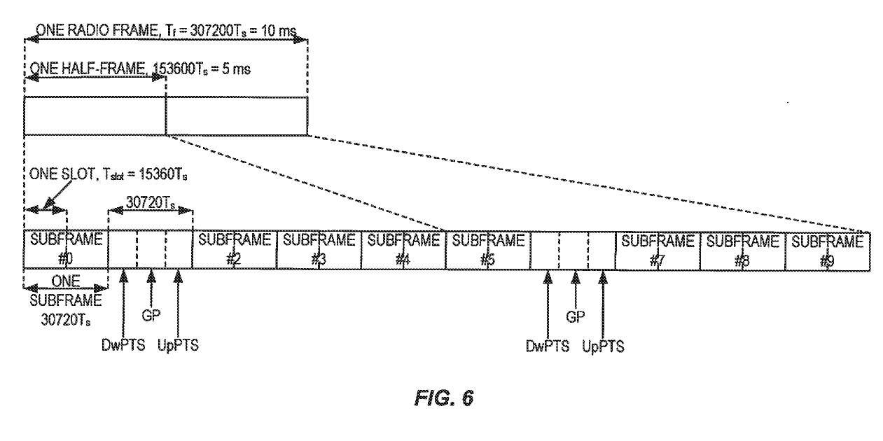

In some embodiments, the term “short inactivity” is used. The short inactivity configuration may be, e.g., the configuration characterized by the inactivity period below a threshold. One example of the short inactivity configuration is a legacy DRX configuration with DRX cycle lengths not exceeding 2.56 seconds. Conversely, one example of the long inactivity configuration is an eDRX configuration with an eDRX cycle length that exceeds 2.56 seconds. In multi-level activity configuration (also referred to herein as a multi-level or multi-tier DRX mode of operation), a UE may also be configured with a short and a long activity cycles in a consecutive manner or in parallel or with short cycles being configured within an activity window (e.g., a Paging Window (PW)) of a the long activity cycle. Herein, a short activity/inactivity period configuration may be DRX, and a long activity/inactivity period configuration may be eDRX. Examples of a multi-tier activity configuration (i.e., a multi-tier DRX mode of operation) are illustrated in FIG. 1B, FIG. 2B, and FIG. 3, which are described above.

The short and UE inactivity configurations may also differ with respect to their activity level and/or inactivity level and/or total cycle length in time (i.e., sum of activity and inactivity durations) within one cycle or period. Each period or cycle comprises of an activity duration (e.g., ON duration) and an inactivity duration (e.g., OFF duration).

The UE behavior to handle short and long UE inactivity configurations may also depend on the UE capability to combine or average measurement samples or snapshots obtained in two successive ON durations or PWs and the ability to use the combined results for one or more operations. Examples of operations are radio measurements, time and/or frequency synchronization or tracking, channel estimation, estimation of Doppler, etc. For example, if the UE can average at least two measurement samples of reference signals received from the serving cell during two successive ON durations or PW of a DRX cycle of certain length (e.g., 2.56 seconds) then this DRX cycle belongs to the category of short UE inactivity configuration. In another example, if the UE cannot average measurement samples of reference signals received from the serving cell during two successive ON durations or PWs of a DRX cycle of length (e.g., 20.48 seconds) then this DRX cycle belongs to the category of long UE inactivity configuration.

Herein the terms “periodicity” and “cycle” may be used interchangeably.

Herein, the terms “activity configuration” and “inactivity configuration” may be used interchangeably.

A non-FDX configuration may be, e.g., any one of: UTRA TDD, LTE TDD, and HD-FDD. A non-FDX configuration may further comprise, e.g., a non-FDX configuration for a carrier frequency or a set of non-FDX configurations for more than one carrier frequencies. In some embodiments, a D2D or Proximity Services (ProSe) configuration (e.g., time- and/or frequency domain configuration for transmissions and receptions) of the UE may also be considered as a non-FDX configuration since the UE performing a D2D/ProSe operation is operating in a non-FDX manner, i.e., it cannot transmit and receive at the same time.

The embodiments herein may apply for UE in a specific activity state (e.g., RRC_CONNECTED or RRC_IDLE) or in any state.

### OVERVIEW OF EMBODIMENTS OF THE PRESENT DISCLOSURE

At least the following problems may be envisioned with the existing solutions for non-FDX operation with a DRX mode of operation with long inactivity periods:
For Measurements on a Serving Carrier: During a short activity time after long inactivity, especially when sample combining or averaging is limited to one cycle only or to a single paging window, there may be not enough signal instances to get a large enough number of samples for the measurement(s) due to non-FDX operation during the short activity times.
   Example: The current requirement in 3GPP LTE for cell detection in RRC_IDLE is 23 legacy DRX cycles for 2.56 cycle length, which is about 60 seconds. This time may be too long to fit into one Paging Window (PW) with eDRX cycle length of 1 minute or even N minutes, depending on the required ratio of the activity and inactivity time within a single time, since if the ratio is e.g. 1:1 (the cycle length is about 2 minutes) there may be no gain with eDRX. Therefore, a few cycles may need to be specified, i.e., a more stringent requirement may be needed, and this requirement may be feasible for FDD but may or may not be feasible for all non-FDX configurations.
For Neighbor Cell Measurements on a Non-Serving Carrier: If during the same paging window the UE will still have to perform some procedure on a serving carrier (e.g., to maintain its tracking or synchronization) in addition to measurements on a non-serving carrier, there may not be enough signal instances to get a large enough number of samples for the measurement(s) due to non-FDX operation and due to sharing the time resources with operation on the serving carrier.
For Measurements on a Serving and/or Non-Serving Carrier with Different Uplink/Downlink Configurations: When a UE is not capable of simultaneous uplink/downlink operation (e.g., due to its Radio Frequency (RF) characteristics as indicated by UE capability), the number of available samples which the UE can get within a paging window may be further reduced.
The UE may need to perform D2D operation, which is non-FDX operation, during a paging window and thus not be able to get a large enough number samples for a measurement(s).

Herein, the described methods provide means for selecting a suitable configuration or adapting one or more procedures (e.g., a measurement procedure) to enable the first node's operation under a non-FDX configuration and long inactivity period configuration while meeting one or more predefined requirements or performance targets.

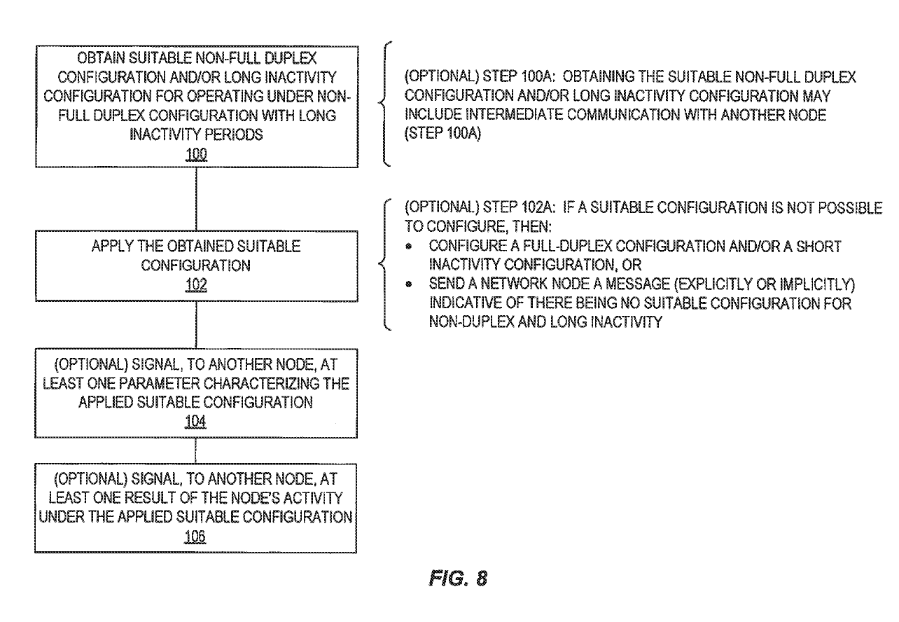

Methods in a first node (e.g., a UE) for operating under non-FDX configuration and configured with long inactivity periods comprising the steps of (see FIG. 8):
Step 100: Obtain suitable non-FDX configuration and/or long inactivity configuration for operating under non-FDX configuration with long inactivity periods;
   Step 100A (optional): Intermediate communication with another node;
Step 102: Apply the obtained suitable configuration;
   Step 102A (optional): Handle the situation when a suitable configuration is not possible to configure;
Step 104 (optional): Signal to another node (e.g., another UE or a network node) at least one parameter characterizing the applied suitable configuration; and
Step 106 (optional): Signal to another node (e.g., another UE or a network node) at least one result (e.g., measurement report) of the first node's activity under the applied suitable configuration.

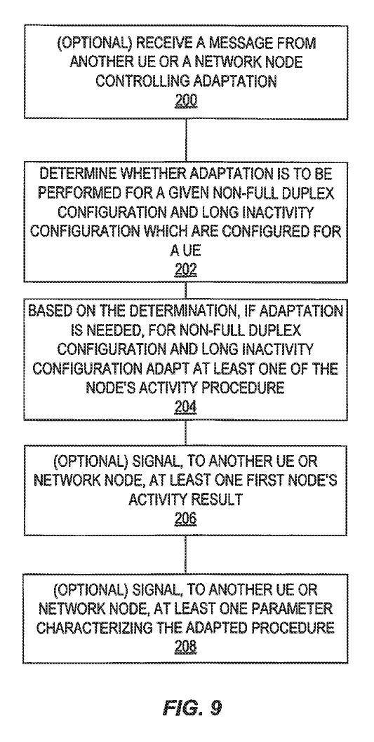

Methods in a first node (e.g., UE) for operating under a given non-FDX configuration and long inactivity configuration comprising the steps of (see FIG. 9):
Step 200 (optional): Receive a message from another UE or a network node controlling the adaptation in step 204 below;
Step 202: Determine whether the adaptation is to be performed for a given non-FDX configuration and long inactivity configuration which are configured for the UE;
Step 204: Based on the determining, if the adaptation is needed, for the given non-FDX configuration and long inactivity configuration, adapt at least one first node's activity procedure (e.g., measurement and/or reporting procedure or UE transmission scheduling, see more UE activity definition above);
Step 206 (optional): signal at least one first node's activity result (e.g., a measurement report) obtained under the adapted procedure to another UE or a network node; and
Step 208 (optional): Signal at least one parameter characterizing the adapted procedure to another UE or a network node.

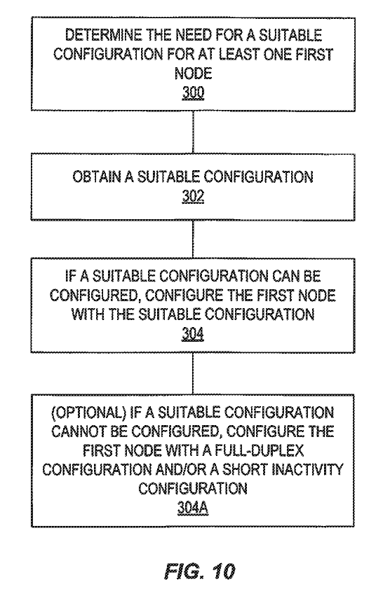

Methods in a second node for providing a suitable configuration to a first node, comprising the steps of (see FIG. 10):
Step 300: Determine the need for a suitable configuration for at least one first node;
Step 302: Obtain a suitable configuration;
Step 304: If a suitable configuration can be configured, then configure the first node with the suitable configuration; and
   Step 304A (optional): If a suitable configuration is not possible to configure, then configure a FDX configuration and/or one of the short inactivity configuration (e.g., DRX instead of eDRX) or no inactivity periods (e.g., no DRX).

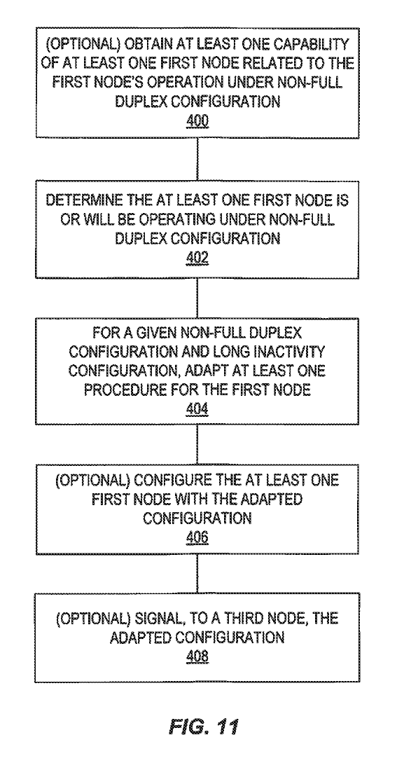

Methods in a second node (e.g., a second UE or a network node) for enabling operation of the first node under a given non-FDX and long inactivity configuration, comprising the steps of (see FIG. 11):
Step 400 (optional): Obtain at least one capability of at least one first node related to the first node's operation under non-FDX configuration;
Step 402: Determine that at least one first node is or will be operating under non-FDX configuration;
Step 404: For a given non-FDX configuration and long inactivity configuration adapt at least one procedure for the first node (e.g., measurement and/or reporting procedure or UE transmission scheduling, see, e.g., more radio node activity definition in the Detailed Description below);
Step 406 (optional): Configure the at least one of the first nodes with the adapted configuration; and
Step 408 (optional): Signal the adapted configuration to a third node, which is different from the second node and the first node.

The present disclosure enables:
The UE to operate under non-FDX configuration with long inactivity periods while ensuring the required performance level;
The UE behavior operating in non-FDX configuration (e.g., HD-FDD, TDD) when configured with long DRX cycle (e.g., eDRX) is well defined and consistent;
The method allows the network to adapt the long inactivity configuration depending on the non-FDX configuration (e.g., proportion of uplink and downlink subframes or time slots);
The network node to control the adaptation of at least one procedure for a UE operating under a non-FDX configuration and with long inactivity configuration.

### Example System Architecture

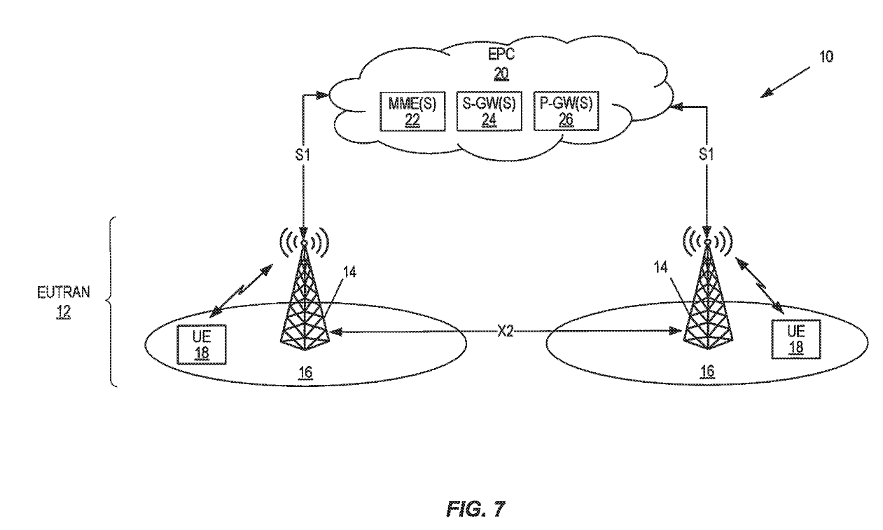

FIG. 7 illustrates one example of a cellular communications network 10 in which embodiments of the present disclosure can be implemented. As illustrated, the cellular communications network 10 includes a Radio Access Network (RAN) 12 (e.g., an Evolved Universal Mobile Telecommunications System (UMTS) RAN (E-UTRAN) for LTE) including base stations 14 providing cells 16 of the cellular communications network 10. The base stations 14 provide radio access to UEs 18 located within the respective cells 16. The base stations 14 may be communicatively coupled via a base station to base station interface (e.g., an X2 interface in LTE). Further, the base stations 14 are connected to a core network 20 (e.g., an Evolved Packet Core (EPC) in LTE) via corresponding interfaces (e.g., S1 interfaces in LTE). The core network 20 includes various core network nodes such as, e.g., MMEs 22, Serving Gateways (S-GWs) 24, and Packet Data Network (PDN) Gateways (P-GWs) 26, as will be appreciated by one of ordinary skill in the art.

### Methods in a First Node for Obtaining Suitable Non-FOX Configuration and/or Long Inactivity Configuration

As illustrated in FIG. 8, embodiments of a method in a first node (e.g., UE 18) for operating under non-FDX configuration and configured with long inactivity periods comprise the steps of:
Step 100: Obtain suitable non-FDX configuration and/or long inactivity configuration for operating under non-FDX configuration with long inactivity periods. A configuration for non-FDX operation in a multi-tier DRX mode of operation with long activity periods may pertain to a suitable configuration for operating under non-FDX configuration with long inactivity periods;
   Step 100A (optional): Intermediate communication with another node;
Step 102; Apply the obtained suitable configuration;
   Step 102A (optional): If a suitable configuration is not possible to configure, then do one of the below:
      configure a FDX configuration and/or one of the short inactivity configuration (e.g., DRX instead of eDRX) or no inactivity periods (e.g., no DRX),
      send to a network node a message indicative of that there is no suitable configuration for non-FDX and long inactivity, comprising an implicit or explicit indication; in one example the message may also comprise a desired fallback configuration which is a FDX configuration and/or one of the short inactivity configuration (e.g., DRX instead of eDRX) or no inactivity periods (e.g., no DRX);
Step 104 (optional): Signal to another node (e.g., another UE or a network node) at least one parameter characterizing the applied suitable configuration; and
Step 106 (optional): Signal to another node (e.g.; another UE or a network node) at least one result (e.g., measurement report) of the first node's activity under the applied suitable configuration.

The suitable long inactivity configuration may be, e.g., the long inactivity configuration characterized by one or more of:
inactivity period is above a threshold;
ratio DURATION_ON/inactivity_time is above a threshold; where “DURATION_ON” refers to the ON duration and “inactivity_time” refers to the inactivity time;
ratio DURATION_ON/activity_cycle_length is above a threshold, where “activity_cycle_length” refers to the activity cycle length;
DURATION_ON is above a threshold;
PW size is above a threshold;
PW size is large enough to cover a certain minimum number of signal samples or subframes of a specific type (e.g., downlink subframes or uplink subframes or special subframes);
short inactivity (e.g., DRX configuration, unlike eDRX which may be a long inactivity) used within a PW meets a certain criteria, e.g., on the activity cycle, DRX cycle, DRX DURATION ON, ratio of DURATION_ON/DRX_cycle, etc.;
number of short and/or long inactivity cycles is above a threshold to enable a sufficient number of signal instances;
number of short inactivity cycles within a PW is above a threshold; and
first node's ability to meet a certain requirement, e.g., an accuracy requirement or measurement period requirement or cell identification requirement.

Thus, in other words, in some embodiments, the suitable long inactivity configuration includes at least one long inactivity configuration parameter being greater than a threshold. As stated above, the at least one long inactivity configuration parameter may include an inactivity period that is above a threshold. As also discussed above, an inactivity period or cycle comprises an activity duration (e.g., ON duration) and an inactivity duration (e.g., OFF duration). Thus, using the example of FIG. 1B as an example, the at least one long inactivity configuration parameter may include, for example, the DRX cycle length T_{DRX}, where T_{DRX} is greater than a threshold. Using the example of FIG. 2B as another example, the at least one long inactivity configuration parameter may include, for example, the PW size, where the PW size is greater than a threshold. As stated above, the described methods provide means for selecting a suitable configuration or adapting one or more procedures (e.g., a measurement procedure) to enable the first node's operation under a non-FDX configuration and long inactivity period configuration while meeting one or more predefined requirements or performance targets. As this indicates, in some embodiments, the thresholds for the respective long inactivity configuration parameters (e.g., the threshold for the inactivity period (e.g., T_{DRX}) and/or the threshold for the PW size) are selected such that one or more predefined requirements or performance targets are met while the first node is operating under the non-FDX configuration and long inactivity period configuration.

The suitable non-FDX configuration may be, e.g., the non-FDX configuration characterized by one or more of:
the time or the number of subframes available for the first node's activity type in question (e.g., a certain measurement or first node's transmissions) is above a threshold;
number of available subframes of a certain type (e.g., downlink only subframes, uplink only subframes, or special subframes)>=N;
number of available signal instances (e.g., reference signals)>=M; the number of uplink/downlink switching points (e.g., in uplink/downlink subframe configurations in TDD) is above a threshold, e.g., >1; and
the first node has a certain capability related to the non-FDX configuration and is capable of operating under the suitable non-FDX configuration (see e.g., the section titled Existing Capabilities Related to Duplex Configuration Support above).

The suitable configuration is a suitable long inactivity configuration or suitable non-FDX configuration or a combination of suitable long inactivity configuration and suitable non-FDX configuration.

### Step 100

The obtaining may comprise one or more of:
Determining in the first node of a suitable non-FDX configuration and/or long inactivity configuration;
Reading a predefined suitable non-FDX configuration and/or long inactivity configuration;
Receiving from another UE 18 or a network node a suitable non-FDX configuration and/or long inactivity configuration;
Obtaining (by determining, reading, or receiving from another node) a set of suitable non-FDX configurations and/or long inactivity configurations; and
Selecting one non-FDX configuration and/or long inactivity configuration from the obtained set. The selecting may be based, e.g., on one or more: a predefined rule, selecting the one which meets a condition or criteria with a larger margin, selecting the one which is least different from the current configuration, selecting the one with the smallest overall activity time, etc.

The obtaining may also account for the first node's capability related to non-FDX configuration and/or long inactivity configurations. The capability may comprise, e.g., UE capability to operate under a certain non-FDX configuration type (e.g., LTE TDD, UTRA TDD, HD-FDD), a certain one or a set of non-FDX configurations (e.g., uplink/downlink TDD configuration #0, #1, #2, #3, but not #4, #5, or #6), UE's ability to support flexible uplink/downlink configuration, UE's ability to perform simultaneous transmission/reception), etc. For example, one configuration may be suitable for one UE but not another one, if they have different capabilities. See other example capabilities in the section titled Existing Capabilities Related to Duplex Configuration Support above.

### Step 100A

See also Methods in a Second Node for Enabling Operation of the First Node under Non-FDX Configuration below.

In one embodiment, Step 100 may also comprise an intermediate communication with a second node (another UE or a network node) (step 100A), e.g.:
Indicating to the second node the obtained set of suitable configurations or a desired suitable configuration and receiving in response one suitable configuration; and
Indicating to the second node the need for a suitable configuration for operating under non-FDX and long inactivity periods and receiving in response the suitable configuration.

### Meeting Requirements with a Suitable Configuration

According to this part of the disclosure, the first node configured with a suitable configuration (see the definition of a suitable configuration above) may also be required to meet one or more predefined requirements, e.g., one or more of: cell selection or reselection requirement, cell detection requirement, measurement requirement, RLM, measurement accuracy requirement, system information reading requirement, a demodulation requirement, CSI reporting requirement, etc.

If there is no suitable configuration found, at least on the requirements cannot be met by the first node.

### Methods in a First Node for Adapting at Least One Activity Procedure for Operating Under a Given Non-FDX and Long Inactivity Configuration

As illustrated in FIG. 9, embodiments of a method in a first node (e.g., UE 18) for operating under non-FDX configuration and configured with long inactivity periods comprise the steps of:
Step 200 (optional): Receive a message from another UE 18 or a network node controlling the adaptation in step 204 below;
Step 202: Determine whether the adaptation is to be performed for a given non-FDX configuration and long inactivity configuration which are configured for the UE 18;
Step 204: Based on the determining; if the adaptation is needed, for non-FDX configuration and long inactivity configuration adapt at least one first node's activity procedure (e.g., measurement and/or reporting procedure or UE transmission scheduling, see more radio node activity definition in the section titled Generalizations above);
Step 206 (optional): Signal at least one first node's activity result (e.g., a measurement report) obtained under the adapted procedure to another UE or a network node; and
Step 208 (optional): Signal at least one parameter characterizing the adapted procedure to another UE or a network node.

### Step 202

The adaptation for a given non-FDX and long inactivity configuration may be needed if, e.g.:
The configuration meets a certain condition; and
The long inactivity cycle is above a threshold.

### Step 204

The adaptation may comprise, e.g., any one or more of the below:
Adapt the measurement period, to meet a requirement which may be different from that for FDX configuration and/or long inactivity configuration, e.g., increase the measurement period to get a sufficient number of samples;
Adapt the sampling rate and/or the number of samples to complete the measurement, e.g., a smaller number of samples may be used if the cycle is above a threshold so that the measurement is limited to one PW;
Adapt the measurement bandwidth, e.g., a longer bandwidth may be considered compared to that under FDX configuration and/or long inactivity configuration;
Accept a worse accuracy compared to that under FDX configuration and/or long inactivity configuration; e.g., if it is not possible to get more samples;
Uplink and/or downlink scheduling adaption;
Drop at least one activity (e.g., a measurement or a transmission) of the first node which cannot meet a certain performance target;
Report a specific error case to a network node or send a message to a network node indicative of that an activity of the first node may not meet at least one performance target;
Adapt the PW size to enable sufficient number of samples;
Adapt the measurement gap configuration to enable sufficient number of samples; and
Adapt the method of combining the samples, e.g., adapt the combining weights.

The adaptation may also account for the first node's capability related to non-FDX configuration and/or long inactivity configurations. The capability may comprise, e.g., UE capability to operate under a certain non-FDX configuration type (e.g., LTE TDD, UTRA TDD, HD-FDD), a certain one or a set of non-FDX configurations (e.g., uplink/downlink TDD configuration #0, #1, #2, #3, but not #4, #5, or #6), UE's ability to support flexible uplink/downlink configuration, UE's ability to perform simultaneous transmission/reception), etc. See other example capabilities in the section titled Existing Capabilities Related to Duplex Configuration Support above.

### Meeting Requirements with the Adapted Procedure

According to this part of the disclosure, the first node may also be required to meet one or more predefined requirements with the adapted procedure, e.g., one or more of: cell selection or reselection requirement, cell detection requirement, measurement requirement, RLM, measurement accuracy requirement, system information reading requirement, a demodulation requirement, CSI reporting requirement, etc.

If the adaptation is not performed, the first node may be not able to meet at east one requirement.

### Methods in a Second Node for Providing a Suitable Configuration to a First Node

As illustrated in FIG. 10, embodiments of a method in a second node (e.g., a network node or another UE 18) for providing a suitable configuration to a first node (e.g., a UE 18), comprise the steps of:
Step 300: Determine the need for a suitable configuration for at least one first node. A configuration for non-FDX operation in a multi-tier DRX mode of operation with long activity periods may pertain to a suitable configuration for operating under non-FDX configuration with long inactivity periods;
Step 302: Obtain a suitable configuration;
Step 304: If a suitable configuration can be configured, then configure the first node with the suitable configuration; and
   Step 304A (optional): If a suitable configuration is not possible to configure, then configure a FDX configuration and/or one of the short inactivity configuration (e.g., DRX instead of eDRX) or no inactivity periods (e.g., no DRX);

A suitable configuration may be similar to a suitable configuration described in the section titled Methods in First Node for Obtaining Suitable Non-full Duplex Configuration and/or Long Inactivity Configuration above.

### Step 300

The determining may be based, e.g., on one or more of:
An indication received from the first node with an implicit or explicit indication for such need;
The UE 18 needs to enter log inactivity (e.g., due to low battery level, not much activity for the first node);
A condition or a trigger; and
Upon determining that the current configuration is not suitable or at least one UE requirement cannot be met with the current configuration.

### Step 302

The obtaining may comprise one or more of:
Determining in the second node of a suitable non-FDX configuration and/or long inactivity configuration;
Reading a predefined suitable non-FDX configuration and/or long inactivity configuration;
Receiving from another UE 18 or another network node a suitable non-FDX configuration and/or long inactivity configuration;
Obtaining (by determining, reading, or receiving from another node) a set of suitable non-FDX configurations and/or long inactivity configurations; and
Selecting one non-FDX configuration and/or long inactivity configuration from the obtained set.

The obtaining may also account for the first node's capability related to non-FDX configuration and/or long inactivity configurations. The capability may comprise, e.g., UE capability to operate under a certain non-FDX configuration type (e.g., LTE TDD, UTRA TDD, HD-FDD), a certain one or a set of non-FDX configurations (e.g., uplink/downlink TDD configuration #0, #1, #2, #3, but not #4, #5, or #6), UE's ability to support flexible uplink/downlink configuration, UE's ability to perform simultaneous transmission/reception), etc. For example, one configuration may be suitable for one UE but not another one, if they have different capabilities.

### Step 304

The step comprises signaling to the first node the suitable configuration by means of unicast, multicast, or broadcast signaling, via physical layer or higher-layer (e.g., Radio Resource Control (RRC)) signaling.

### Meeting Requirements with a Suitable Configuration

According to this part of the disclosure, the first node configured with a suitable configuration (see the definition of a suitable configuration above) may also be required to meet one or more predefined requirements, e.g., one or more of: cell selection or reselection requirement, cell detection requirement, measurement requirement, RLM, measurement accuracy requirement, system information reading requirement, a demodulation requirement, CSI reporting requirement, etc.

If there is no suitable configuration found, at least on the requirements cannot be met by the first node.

### Methods in a Second Node for Enabling Operation of the First Node Under Non-FDX Configuration

As illustrated in FIG. 11, embodiments of a method in a second node (e.g., a second UE 18 or a network node) for enabling operation of the first node (e.g., a first UE 18) under non-FDX configuration, comprise the steps of:
Step 400 (optional): Obtain at least one capability of at least one first node related to the first node's operation under non-FDX configuration;
Step 402: Determine that at least one first node is or will be operating under non-FDX configuration;
Step 404: For a given non-FDX configuration and long inactivity configuration, adapt at least one procedure for the first node (e.g., measurement and/or reporting procedure or UE transmission scheduling, see, e.g., more radio node activity definition above);
Step 406 (optional): Configure the at least one of the first nodes with the adapted configuration; and
Step 408 (optional): Signal the adapted configuration to a third node, which is different from the second node and the first node.

### Step 400

The capability may comprise, e.g., UE capability to operate under a certain non-FDX configuration type (e.g., LTE TDD, UTRA TDD, HD-FDD), a certain one or a set of non-FDX configurations (e.g., uplink/downlink TDD configuration #0, #1, #2, #3, but not #4, #5, or #6), UE's ability to support flexible uplink/downlink configuration, UE's ability to perform simultaneous transmission/reception), etc. See other example capabilities in the section titled Existing Capabilities Related to Duplex Configuration Support above.

The obtained capability may be further accounted in the adaptation step.

### Step 404

The adaptation may comprise, e.g., any one or more of the below:
Adapt the measurement period, to meet a requirement which may be different from that for FDX configuration and/or long inactivity configuration;
Adapt the sampling rate and/or the number of samples to complete the measurement, e.g., a smaller number of samples may be used;
Adapt the measurement bandwidth, e.g., a longer bandwidth may be considered compared to that under FDX configuration and/or long inactivity configuration;
Accept a worse accuracy compared to that under FDX configuration and/or long inactivity configuration;
Uplink and/or downlink scheduling adaption;
Drop or reconfigure in a hard way (the result based on the old configuration is dropped) at least one activity (e.g., a measurement or a transmission) of the first node which cannot meet a certain performance target;
Adapt the waiting time for a measurement report from the first node;
Adapt the PW size of the first node to enable sufficient number of samples;
Adapt the measurement gap configuration for the first node to enable sufficient number of samples; and
Control adaptively the method of combining the samples, e.g., adapt the combining weights.

### Meeting Requirements with the Adapted Procedure

According to this part of the disclosure, the first node may also be required to meet one or more predefined requirements with the adapted procedure, e.g., one or more of: cell selection or reselection requirement, cell detection requirement, measurement requirement, RLM, measurement accuracy requirement, system information reading requirement, a demodulation requirement, CSI reporting requirement, etc. If the adaptation is not performed, the first node may be not able to meet at least one requirement.

### Example Embodiments of the UE and Base Station

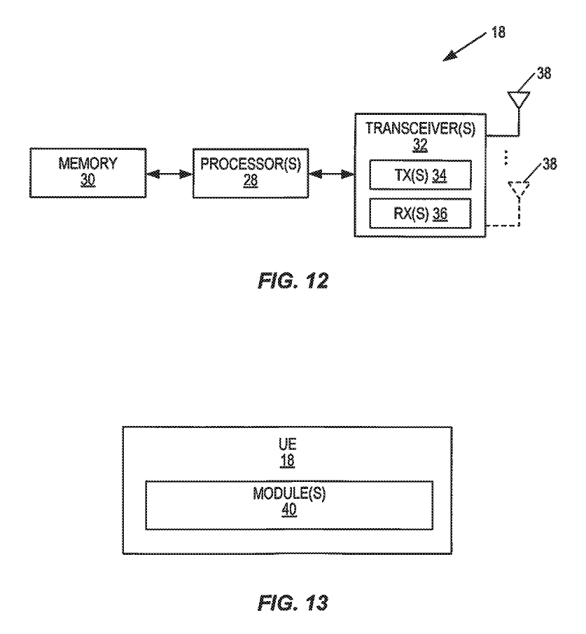

FIG. 12 is a block diagram of the UE 18 according to some embodiments of the present disclosure. As illustrated, the UE 18 includes one or more processors 28 (e.g., one or more Central Processing Units (CPUs), one or more Application Specific Integrated Circuits (ASICs), one or more Field Programmable Gate Arrays (FPGAs), or the like, or any combination thereof), memory 30, and one or more transceivers 32 including one or more transmitters 34 and one or more receivers 36 coupled to one or more antennas 38. In some embodiments, the functionality of the UE 18 described herein is implemented in software, which is stored in the memory 30 and executed by the processor(s) 28.

In some embodiments, a computer program including instructions which, when executed by at least one processor, causes the at least one processor to carry out the functionality of the UE 18 according to any of the embodiments described herein is provided. In some embodiments, a carrier containing the aforementioned computer program product is provided. The carrier is one of an electronic signal, an optical signal, a radio signal, or a computer readable storage medium (e.g., a non-transitory computer readable medium such as the memory 30).

FIG. 13 is a block diagram of the UE 18 according to some other embodiments of the present disclosure. As illustrated, the UE 18 includes one or more modules 40, each of which is implemented in software. The module(s) 40 operate to provide the functionality of the UE 18 according to any of the embodiments described above with respect to FIGS. 8-11.

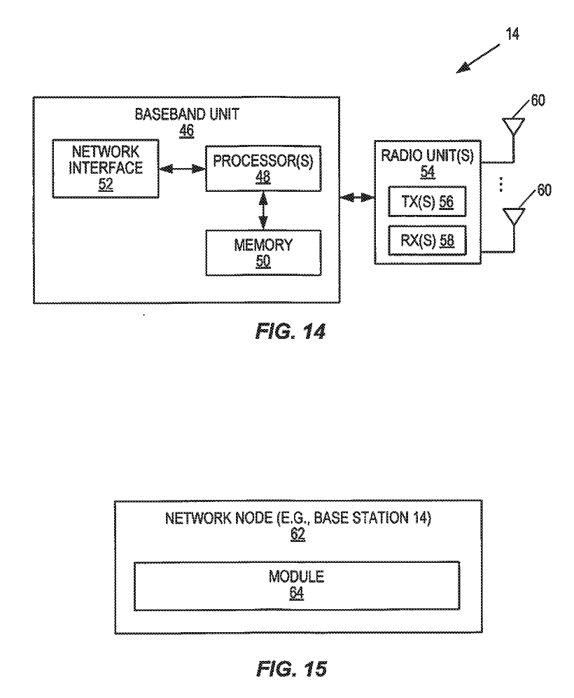

FIG. 14 is a block diagram of the base station 14 according to some embodiments of the present disclosure. As illustrated, the base station 14 includes a baseband unit 46 that includes one or more processors 48 (e.g., one or more CPUs, one or more ASICs, one or more FPGAs, and/or the like, or any combination thereof), memory 50, and a network interface 52 (e.g., a network interface providing a connection to the core network 20 and/or other base stations 14). The base station 14 also includes one or more radio units 54 including one or more transmitters 56 and one or more receivers 58 connected to one or more antennas 60. In some embodiments, the functionality of the network node described herein is implemented in software, which is stored in the memory 50 and executed by the processor(s) 48.

Note that other network nodes may include components similar to those of the baseband unit 46 illustrated in FIG. 14.

In some embodiments, a computer program including instructions which, when executed by at least one processor, causes the at least one processor to carry out the functionality of the network node (e.g., the base station 14) according to any of the embodiments described herein is provided. In some embodiments, a carrier containing the aforementioned computer program product is provided. The carrier is one of an electronic signal, an optical signal, a radio signal, or a computer readable storage medium (e.g., a non-transitory computer readable medium such as the memory 50).

FIG. 15 is a block diagram of a network node 62 (e.g., the base station 14) according to some other embodiments of the present disclosure. As illustrated, the network node 62 includes one or more modules 64, each of which is implemented in software. The module(s) 64 operate to provide the functionality of the network node 62 according to any of the embodiments described above with respect to FIGS. 8-11.

### EXEMPLARY EMBODIMENTS

While various embodiments are described herein, some exemplary embodiments are as follows.

### Embodiment 1

A method of operation of a first node of a cellular communications network comprising:

obtaining a suitable configuration for operating under non-FDX configuration with long inactivity periods, the suitable configuration comprising at least one of a suitable non-FDX configuration and a suitable long inactivity configuration; and applying the suitable configuration.

### Embodiment 2

The method of embodiment 1 wherein the suitable configuration comprises a suitable non-FDX configuration.

### Embodiment 3

The method of embodiment 1 wherein the suitable configuration comprises a suitable long inactivity configuration.

### Embodiment 4

The method of embodiment 1 wherein the suitable configuration comprises a combination of the suitable non-FDX configuration and the suitable long inactivity configuration.

### Embodiment 5

The method of any of embodiments 1-4 wherein obtaining the suitable configuration comprises determining the suitable configuration at the first node.

### Embodiment 6

The method of any of embodiments 1-4 wherein obtaining the suitable configuration comprises reading a predefined suitable configuration.

### Embodiment 7

The method of any of embodiments 1-4 wherein obtaining the suitable configuration comprises receiving an indication of the suitable configuration from another node.

### Embodiment 8

The method of any of embodiments 1-4 wherein obtaining the suitable configuration comprises obtaining a set of suitable configurations.

### Embodiment 9

The method of any of embodiments 1-4 wherein obtaining the suitable configuration comprises obtaining a set of suitable configurations and selecting the suitable configuration from the set of suitable configurations.

### Embodiment 10

The method of any of embodiments 1-9 wherein obtaining the suitable configuration comprises performing an intermediate communication with a second node.

### Embodiment 11

The method of any of embodiments 1-10 further comprising signaling, to another node, at least one parameter that characterizes the suitable configuration applied by the first node.

### Embodiment 12

The method of any of embodiments 1-11 further comprising signaling, to another node, at least one result of an activity of the first node under the suitable configuration applied by the first node.

### Embodiment 13

The method of any of embodiments 1-12 wherein the first node is a UE.

### Embodiment 14

A method of operation of a first node of a cellular communications network, comprising:

determining whether an adaptation is to be performed for a given non-FDX configuration and long inactivity configuration which are configured for the first node; and

based on the determining, if adaptation is to be performed, adapting at least one activity procedure of the first node for the given non-FDX configuration and long activity configuration.

### Embodiment 15

The method of embodiment 14 wherein determining whether an adaptation is to be performed comprises determining that adaptation is to be performed if the given non-FDX configuration and long inactivity configuration meets a predefined configuration.

### Embodiment 16

The method of embodiment 14 wherein determining whether an adaptation is to be performed comprises determining that adaptation is to be performed if a long inactivity cycle defined by the long inactivity configuration is above a predefined threshold.

### Embodiment 17

The method of any of embodiments 14-16 further comprising signaling, to anther node, at least one result of the at least one activity procedure adapted by the first node.

### Embodiment 18

The method of any of embodiments 14-17 further comprising signaling, to another node, at least one parameter characterizing the at least one activity procedure adapted by the first node.

### Embodiment 19

The method of embodiments 14-18 wherein the first node is a first UE.

### Embodiment 20

A method of operation of a second node for providing a suitable configuration to a first node, comprising:

determining that there is a need for a suitable configuration for a first node;

obtaining a suitable configuration for the first node; and

configuring the first node with the suitable configuration.

### Embodiment 21

The method of embodiment 20 wherein configuring the first node with the suitable configuration comprises configuring the first node with the suitable configuration if there is a suitable configuration that can be configured for the first node.

### Embodiment 22

The method of embodiment 21 further comprising, if there is no suitable configuration that can be configured for the first node, configuring the first node with a FDX configuration and/or a short inactivity configuration.

### Embodiment 23

A method of operation of a second node for enabling operation of a first node under non-full duplex configuration, comprising:

determining that a first node is or will be operating under non-FDX configuration; and

for a given non-FDX configuration and long inactivity configuration, adapting at least one procedure for the first node.

### Embodiment 24

The method of embodiment 23 further comprising configuring the first node with the at least one adapted procedure.

### Embodiment 25

The method of any of embodiments 23 and 24 further comprising signaling, to a third node, the adapted procedure.

The following acronyms are used throughout this disclosure.
2G 2^{nd} Generation
3G 3^{rd} Generation
3GPP 3^{rd} Generation Partnership Project
ACK Acknowledgement
ASIC Application Specific Integrated Circuit
CA Carrier Aggregation
CC Component Carrier
CGI Cell Global Identifier
CPE Customer Premises Equipment
CPICH Common Pilot Channel
CPU Central Processing Unit
CQI Channel Quality Indication
C-RNTI Cell Radio Network Temporary Identifier
CRS Cell-Specific Reference Signal
CSI Channel State Information
CSI-RS Channel State Information Reference Signal
D2D Device-to-Device
dB Decibel
DRS Discovery Reference Signal
DRX Discontinuous Reception
EARFCN Evolved Universal Terrestrial Radio Access Absolute Radio Frequency Channel Number
ECGI Evolved Universal Terrestrial Radio Access Cell Global Identifier
eDRX Extended Discontinuous Reception
eNB Enhanced or Evolved Node B
EPC Evolved Packet Core
E-PDCCH Enhanced Physical Downlink Control Channel
E-SMLC Evolved Serving Mobile Location Centre
E-UTRA Evolved Universal Terrestrial Radio Access
E-UTRAN Evolved Universal Mobile Telecommunications System Radio Access Network
FDD Frequency Division Duplexing
FDX Full-Duplex
FPGA Field Programmable Gate Array
GSM Global System for Mobile Communications
HARQ Hybrid Automatic Repeat Request
HD-FDD Half-Duplex Frequency Division Duplexing
HDX Half-Duplex
H-SFN Hyper System Frame Number
HSPA High Speed Packet Access
ID Identifier
IDC In-Device Coexistence
LEE Laptop Embedded Equipment
LME Laptop Mounted Equipment
LMU Location Measurement Unit
LTE Long Term Evolution
M2M Machine-to-Machine
MAC Medium Access Control
MBMS Multimedia Broadcast/Multicast Service
MCE Multi-Cell/Multicast Coordination Entity
MDT Minimization of Drive Tests
MME Mobility Management Entity
M-PDCCH Machine Type Communication Physical Downlink Control Channel
M-PDSCH Machine Type Communication Physical Downlink Shared Channel
ms Millisecond
MTC Machine Type Communication
NACK Negative Acknowledgement
PCC Primary Component Carrier
PCell Primary Cell
PDCCH Physical Downlink Control Channel
PDN Packet Data Network
PDSCH Physical Downlink Shared Channel
P-GW Packet Data Network Gateway
PH Paging Hyper-Frame
PMI Preceding Matrix Indicator
ProSe Proximity Services
PSC Primary Serving Cell
PSS Primary Synchronization Signal
PTI Procedure Transaction Identity
PTW Paging Transmission Window
PUCCH Physical Uplink Control Channel
PW Paging Window
RAN Radio Access Network
RF Radio Frequency
RI Rank Indicator
RLM Radio Link Monitoring
RRC Radio Resource Control
RRH Remote Radio Head
RRU Remote Radio Unit
RS Reference Signal
RSCP Received Signal Code Power
RSRP Reference Signal Received Power
RSRQ Reference Signal Received Quality
RSSI Received Signal Strength Indicator
RSTD Reference Signal Time Difference
RTT Round Trip Time
SCC Secondary Component Carrier
SCell Secondary Cell
SFN System Frame Number
S-GW Serving Gateway
SINR Signal to Interference plus Noise Ratio
SNR Signal to Noise Ratio
SRS Sounding Reference Signal
SSC Secondary Serving Cell
SSS Secondary Synchronization Signal
TCE Trace Collection Entity
TDD Time Division Duplexing
TS Technical Specification
TTI Transmission Time Interval
UE User Equipment
UMTS Universal Mobile Telecommunications System
USB Universal Serial Bus
UTRA Universal Terrestrial Radio Access

Those skilled in the art will recognize improvements and modifications to the embodiments of the present disclosure. All such improvements and modifications are considered within the scope of the concepts disclosed herein.

1. A method of operation of a first node for a cellular communications network, comprising:
obtaining a configuration for non-full duplex operation in a multi-tier Discontinuous Reception, DRX, mode of operation with long inactivity periods, the configuration comprising at least one long inactivity configuration parameter being greater than a threshold; and
applying the configuration.

2. The method of claim 1 wherein the multi-tier DRX mode of operation is a two-tier DRX mode of operation that utilizes a first DRX cycle that defines a set of first DRX ON periods and a second DRX cycle that defines, during each first DRX ON period, a set of second DRX ON periods within the first DRX ON period during which the first node is awake.

3. The method of claim 1 wherein the multi-tier DRX mode of operation is a two-tier DRX mode of operation for the first node when operating in IDLE mode that utilizes a first DRX cycle that defines a set of first DRX ON periods and a second DRX cycle that defines, during each first DRX ON period, a set of second DRX ON periods within the first DRX ON period during which the first node is awake.

4. The method of claim 1 wherein the multi-tier DRX mode of operation is a two-tier DRX mode of operation that utilizes a first DRX cycle that defines a set of first paging hyper-frames and a second DRX cycle that defines, during each paging hyper-frame, a set of paging frames within the paging hyper-frame during which the first node expects to be paged.

5. The method of claim 1 wherein the at least one long inactivity configuration parameter comprises an inactivity period that is greater than a threshold.

6. The method of claim 1 wherein the at least one long inactivity configuration parameter comprises a paging window size that is greater than a threshold.

7. The method of claim 1 wherein the at least one long inactivity configuration parameter comprises an inactivity period that is greater than an inactivity period threshold and a paging window size that is greater than a paging window size threshold.

8. The method of claim 1 wherein the at least one long inactivity configuration parameter comprises a paging window size that is large enough to cover a certain minimum number of signal samples or subframes of a specific type.

9. The method of claim 1 wherein the configuration further comprises a non-full duplex configuration.

10. The method of claim 9 wherein the non-full duplex configuration comprises at least one of a group consisting of:
a non-full duplex configuration that provides an amount of time or number of subframes available for an activity type of the first node that is greater than a threshold;
a non-full duplex configuration that provides a number of subframes of a certain type that is greater than or equal to a threshold;
a non-full duplex configuration that provides a number of signal instances that is greater than or equal to a threshold; and
a non-full duplex configuration that provides a number of uplink/downlink switching points that is greater than a threshold.

11. The method of claim 1 wherein the non-full duplex configuration is a Time Division Duplexing, TDD, configuration.

12. The method of claim 1 wherein the non-full duplex configuration is a half-duplex Frequency Division Duplexing, FDD, configuration.

13. The method of claim 1 wherein the first node is a User Equipment device, UE.

14. (canceled)

15. (canceled)

16. A first node for a cellular communications network, comprising:
at least one processor; and
memory comprising instructions executable by the at least one processor whereby the first node is operable to:
obtain a configuration for non-full duplex operation in a multi-tier Discontinuous Reception, DRX, mode of operation with long inactivity periods, the configuration comprising at least one long inactivity configuration parameter being greater than a threshold; and
apply the configuration.

17-28. (canceled)

29. A method of operation of a first node for a cellular communications network, comprising:
determining whether an adaptation is to be performed for a given non-full duplex configuration and a long inactivity configuration which are configured for the first node for operating under the non-full duplex configuration in a multi-tier Discontinuous Reception, DRX, mode of operation with long inactivity periods; and
based on the determining, if adaptation is to be performed, adapting at least one activity procedure of the first node for the given non-full duplex configuration and the long activity configuration.

30. The method of claim 29 wherein adapting the at least one activity procedure of the first node comprises adapting a measurement period.

31. The method of claim 30 wherein adapting the measurement period comprises adapting the measurement period such that the first node is enabled to obtain a sufficient number of samples for a respective measurement when operating under the non-full duplex configuration and the long inactivity configuration.

32. The method of claim 29 wherein determining whether an adaptation is to be performed comprises determining that adaptation is to be performed if the given non-full duplex configuration and the long inactivity configuration meet a predefined configuration.

33. The method of claim 29 wherein determining whether an adaptation is to be performed comprises determining that adaptation is to be performed if a long inactivity cycle defined by the long inactivity configuration is above a predefined threshold.

34. The method of claim 29 wherein the first node is a first User Equipment device, UE.

35. (canceled)

36. (canceled)

37. A first node for a cellular communications network, comprising:
at least one processor; and
memory comprising instructions executable by the at least one processor whereby the first node is operable to:
determine whether an adaptation is to be performed for a given non-full duplex configuration and long inactivity configuration which are configured for the first node for operating under the non-full duplex configuration in a multi-tier Discontinuous Reception, DRX, mode of operation with long inactivity periods; and
based on the determining, if adaptation is to be performed, adapt at least one activity procedure of the first node for the given non-full duplex configuration and long activity configuration.

38-45. (canceled)
